(19) United States
(12) Patent Application Publication
(10) Pub. No.: US 2016/0351884 A1
(43) Pub. Date: Dec. 1, 2016

(54) Lithium Battery Core

(71) Applicant: DIJIYA ENERGY SAVING TECHNOLOGY INC., New Taipei City (TW)

(72) Inventor: Wen-Hung Huang, New Taipei City (TW)

(21) Appl. No.: 15/165,892

(22) Filed: May 26, 2016

(30) Foreign Application Priority Data
May 29, 2015 (TW) 104117536

(51) Int. Cl. H01M 2/26; H01M 10/0587; H01M 2/30; H01M 2/04; H01M 2/06; H01M 10/0525; H01M 2/02

(52) U.S. Cl. CPC H01M 2/263; H01M 10/0525; H01M 10/0587; H01M 2/0217; H01M 2/024; H01M 2/0404; H01M 2/043; H01M 2/06; H01M 2/30; H01M 2/026; H01M 2/0262; H01M 2/0275

(57) ABSTRACT

A lithium battery core is formed by providing an anode and a cathode tab set at two lateral sides of a winding core in a lower case and connecting a first and a second terminal component to a cover plate. The first and second terminal components are respectively in electrical connection with a first positioning part of a cathode conductive sheet and a second positioning part of an anode conductive sheet. A first extending part extends downwardly from one side of the first positioning part in a direction perpendicular to the first positioning part and is connected with the cathode tab set. A second extending part extends downwardly from one side of the second positioning part in a direction perpendicular to the second positioning part and is connected with the anode tab set, so as to fulfill the requirement of charge/discharge of high-rate large current.

### BACKGROUND OF THE INVENTION

1. Field of Invention

The present invention relates to a lithium battery core, and more particularly, to a lithium battery core suitable for the charge and discharge of high-rate and large current and safe to be used.

2. Prior Art

A conventional lithium battery core mainly comprises a case within which an electrolyte solution and a lithium battery winding core are located. The lithium battery winding core is formed by continuous winding an anode plate, an insulation sheet, and a cathode plate. The anode plate is welded with an anode tab, and the anode tab is then welded onto the internal wall of the case, so as to establish an electrical connection between the case and a anode terminal post. The cathode plate is welded with a cathode tab, and the cathode tab is then welded upwardly onto the bottom of a cathode terminal post of the case. Thereby, the anode terminal post and the cathode terminal post can be respectively screwed into a nut through an external screw thread disposed on a top of the anode terminal post and the cathode terminal post for fixing different wiring terminals, so as to output a positive and a negative power respectively.

However, since the cathode tab is extended from the cathode plate and then welded to the bottom of the cathode terminal post, and thus its processing procedure is complicated. Moreover, because the anode tab is welded onto the internal wall of the case and the cathode tab is welded to the cathode terminal post, it would be difficult to control the welding quality and the contacts are usually only of point contacts. Therefore, it would cause the shortcomings such as poor conduction and poor heat dissipation, and thus is only suitable for the electricity storage of small current, but not for the charge and discharge of high-rate and large current.

### SUMMARY OF THE INVENTION

In view of the shortcomings mentioned above, the present invention is aimed at providing a novel structure distinguished from the conventional one and at overcoming these drawbacks.

An object of the present invention is to provide a lithium battery core formed by providing a cathode tab set and an anode tab set respectively at two lateral sides of a winding core and establishing a large-area electrical connection between the cathode and the anode conductive sheets and the cathode and the anode tab sets, so as to overcome the shortcomings such as the poor conduction and poor heat dissipation, and consequently make the conduction and heat dissipation effective while ensure the safety of use.

Another object of the present invention is to provide a lithium battery core formed by providing a cathode tab set and an anode tab set respectively at two lateral sides of a winding core and establishing a large-area electrical connection between the cathode and the anode conductive sheets and the cathode and the anode tab sets, so as to overcome the shortcoming that the welding quality is difficult to be controlled because the welding is in point contacts and thus the conventional lithium battery is only suitable to be used for the electricity storage of small current, and consequently fulfill the requirement for the charge and discharge of high rate and large current.

In order to achieve the above-mentioned objects, the present invention provides a lithium battery core comprising a lower case and a cover plate provided to cover the lower case's top, where the cover plate is provided with a first terminal component and a second terminal component; an electrolyte solution and at least a winding core are received in the lower case; the winding core has a cathode tab set and an anode tab set, the cathode tab set is in electrical connection with the first terminal component while the anode tab set in electrical connection with the second terminal component. The lithium battery core is characterized in that: the cathode tab set and the anode tab set are respectively located at two lateral sides of the winding core; the first terminal component has a bottom connected with a cathode conductive sheet, and the cathode conductive sheet includes a first positioning part and a first extending part; the first positioning part is in electrical connection with the first terminal component, and the first extending part extends downwardly from one side of the first positioning part in a direction of being generally perpendicular to the first positioning part; and the first extending part is connected with the cathode tab set; and the second terminal component has a bottom connected with an anode conductive sheet, and the anode conductive sheet includes a second positioning part and a second extending part; the second positioning part is in electrical connection with the second terminal component, and the second extending part extends downwardly from one side of the second positioning part in a direction of being generally perpendicular to the second positioning part; and the second extending part is connected with the anode tab set.

In implementation, the first extending part and the second extending part respectively have a U-shape cross-section while the first positioning part and the first extending part are in inverse L-shape.

In implementation, the cathode conductive sheet further includes a third extending part. The third extending part extends downwardly from another side of the first positioning part in a direction of being generally perpendicular to the first positioning part. The first positioning part, the first extending part, and the third extending part are in inverse U-shape.

In implementation, the second positioning part and the second extending part are in inverse L-shape. The anode conductive sheet further includes a fourth extending part. The fourth extending part extends downwardly from another side of the second positioning part in a direction of being generally perpendicular to the second positioning part. The second positioning part, the second extending part, and the fourth extending part are in inverse U-shape.

In implementation, the present invention further comprises a first conductive sheet and a second conductive sheet, wherein the first conductive sheet is attached to the first positioning part of the cathode conductive sheet while the second conductive sheet is attached to the second positioning part of the anode conductive sheet.

In implementation, the cathode tab set has a top formed with a first upper notch, and the cathode tab set has a bottom formed with a first lower notch. The anode tab set has a top formed with a second upper notch, and the anode tab set has a bottom formed with a second lower notch.

In implementation, the present invention further comprises an insulating sleeve, wherein the lower case is made of metal material, and the insulating sleeve covers the winding core and is located between the winding core and the lower case.

The present invention will become more fully understood by reference to the following detailed description thereof when read in conjunction with the attached drawings.

### BRIEF DESCRIPTION OF THE DRAWINGS

FIG. 1 is an exploded perspective view showing a first embodiment according to the present invention.

FIG. 2 is a perspective view showing the first embodiment according to the present invention.

FIG. 3 is a perspective view showing a first and a second conductive sheet in a second embodiment according to the present invention.

FIG. 4 is a perspective view showing a first and a second conductive sheet in a third embodiment according to the present invention.

FIG. 5 is a perspective view showing a fourth embodiment according to the present invention.

### DETAILED DESCRIPTION OF THE INVENTION

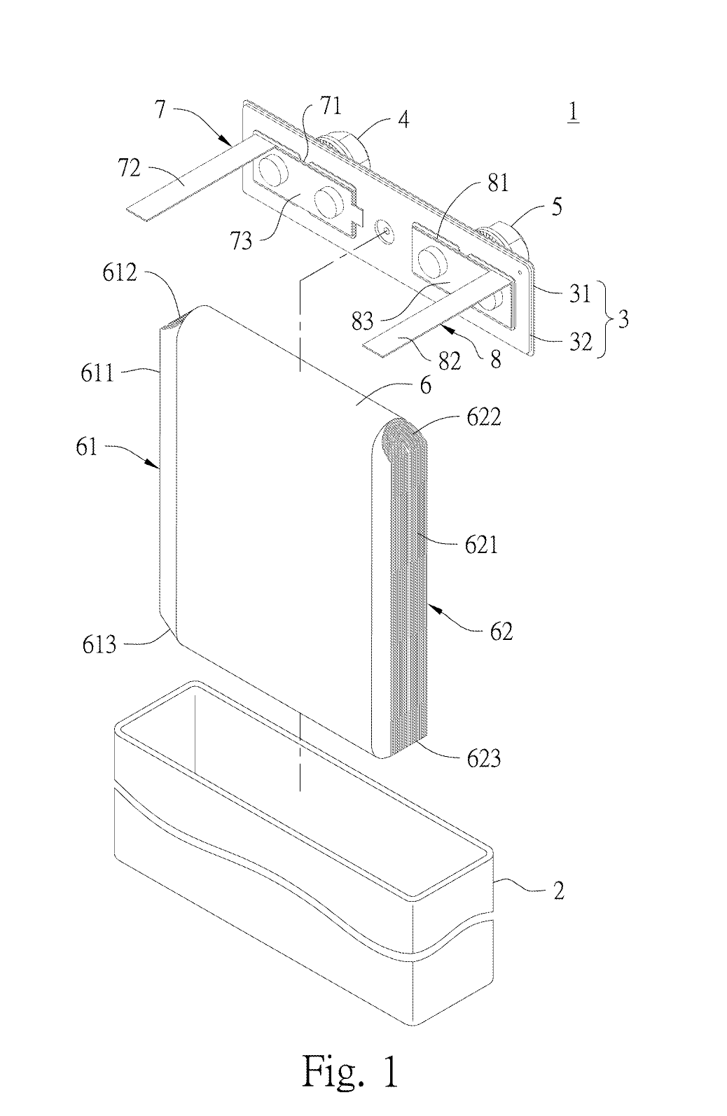

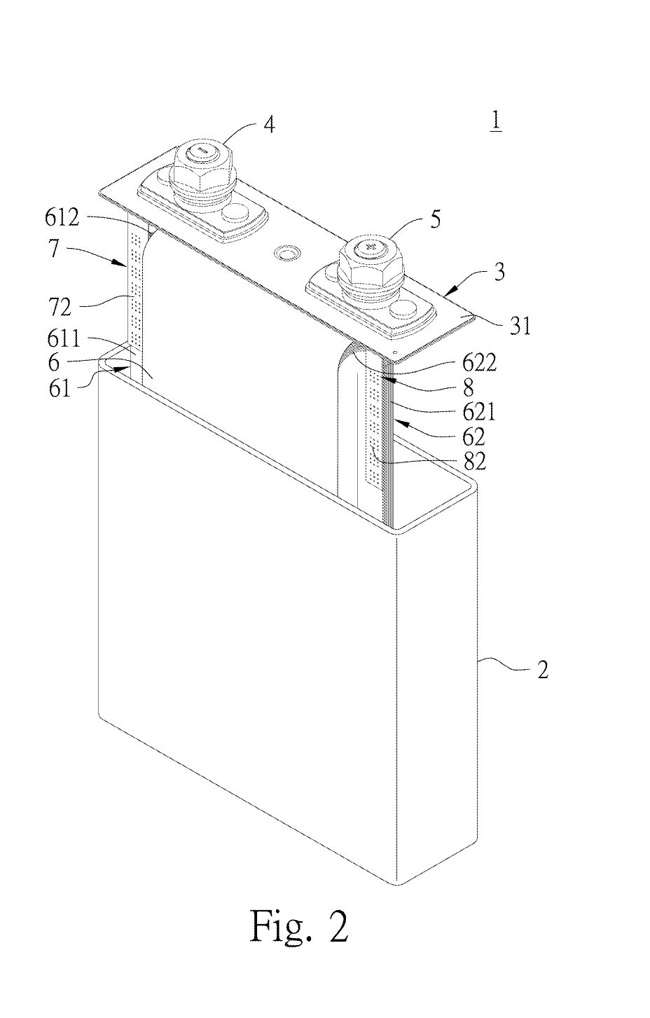

Please refer to FIGS. 1 and 2, which show a first embodiment of a lithium battery core 1 according to the present invention. The lithium battery core 1 comprises a lower case 2, a cover plate 3, a first terminal component 4, a second terminal component 5, at least one winding core 6, a cathode conductive sheet 7, and an anode conductive sheet 8.

The lower case 2 is a hollow cuboid and has an opening on its top. An electrolyte solution is received in the lower case 2. The cover plate 3 covers the top of the lower case 2 so as to enclose the opening. The cover plate 3 includes a top sheet 31 and an insulating sheet 32, and the top sheet 31 and the insulating sheet 32 are laminated with each other. The first and second terminal component 4, 5 are located respectively above the two plastic sleeves on the surface of the cover plate 3.

The winding core 6 is received within the lower case 2. The winding core 6 is preferably formed by laminating a rectangular anode plate, a first separating film, a rectangular cathode plate, and a second separating film, and then winding the laminated combination. A plurality of cathode tabs 611 are formed at one side of the winding core 6 and the plurality of cathode tabs 611 is laminated and pressurized to form a cathode tab set 61. A plurality of anode tabs 621 are formed at another side of the winding core 6 and the plurality of anode tabs 621 are laminated and pressurized to form an anode tab set 62. The tops and the bottoms of the cathode tab set 61 and the anode tab set 62 are processed with angle cutting treatment, so as to form a first upper notch 612 at the top of the cathode tab set 61, a first lower notch 613 at the bottom of the cathode tab set 61, a second upper notch 622 at the top of the anode tab set 62, and a second lower notch 623 at the bottom of the anode tab set 62.

The cathode conductive sheet 7 is formed by bending a flat sheet and includes a first positioning part 71 and a first extending part 72. The first extending part 72 is extended downwardly from one side of the first positioning part 71 in a direction of being generally perpendicular to the first positioning part 71, so that the first positioning part 71 and the first extending part 72 together are generally in an inverse L-shape. The vertical length of the first extending part 71 is preferably longer than one-third of the the vertical height of the cathode tab set 61. The first positioning part 71 and a first conductive sheet 73 are superimposed with each other. The first positioning part 71 and the first conductive sheet 73 are located below the cover plate 3 and are riveted to be fixed with the first terminal component 4, so that the first positioning part 71, the first conductive sheet 73, and the first terminal component 4 are in electrical connection. The first extending part 72 is welded to be connected with the cathode tab set 61 at one side of the winding core 6.

The anode conductive sheet 8 is formed by bending a flat sheet and includes a second positioning part 81 and a second extending part 82. The second extending part 82 is extended downwardly from one side of the second positioning part 81 in a direction of being generally perpendicular to the second positioning part 81, so that the second positioning part 81 and the second extending part 82 together are generally in an inverse L-shape. The vertical length of the second extending part 81 is preferably longer than one-third of the the vertical height of the anode tab set 62. The second positioning part 81 and a second conductive sheet 83 are superimposed with each other. The second positioning part 81 and the second conductive sheet 83 are located below the cover plate 3 and are riveted to be fixed with the second terminal component 5, so that the second positioning part 81, the second conductive sheet 83, and the second terminal component 5 are in electrical connection. The second extending part 82 is welded to be connected with the anode tab set 62 at another side of the winding core 6.

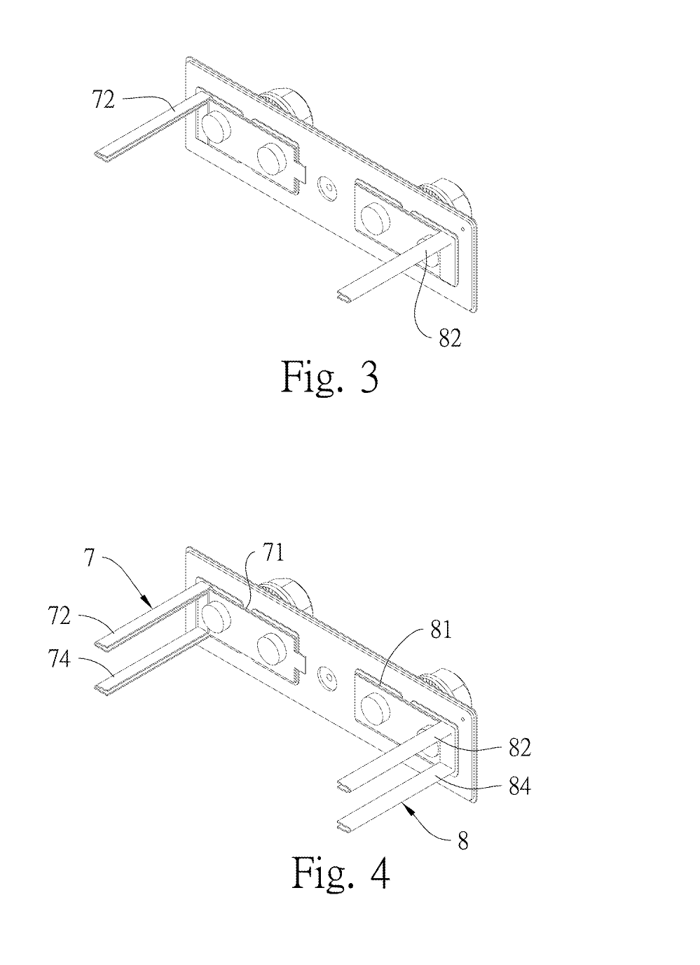

Please refer to FIG. 3, which shows a second embodiment of a lithium battery core according to the present invention. The second embodiment is different from the first one in that: the first extending part 72 and the second extending part 82 are further bent, so that the cross-sections of the first extending part 72 and the second extending part 82 are respectively in U-shape. In this way, it is able to increase the welding area between the first extending part 72 and the cathode tab set 61 while increase the welding area between the second extending part 82 and the anode tab set 62.

Please refer to FIG. 4, which shows a third embodiment of a lithium battery core according to the present invention. In this embodiment, the cathode conductive sheet 7 further includes a third extending part 74. The third extending part 74 is extended downwardly from another side of the first positioning part 71 in a direction of being generally perpendicular to the first positioning part 71, so that the first positioning part 71, the first extending part 72, and the third extending part 74 together are in an inverse U-shape. The anode conductive sheet 8 further includes a fourth extending part 84. The fourth extending part 84 is extended downwardly from another side of the second positioning part 81 in a direction of being generally perpendicular to the second positioning part 81, so that the second positioning part 81, the second extending part 82, and the fourth extending part 84 together are in U-shape. Thereby, the first extending part 72 and the third extending part 74 could be respectively welded to the cathode tab sets 61 of different winding cores 6 while the second extending part 82 and the fourth extending part 84 could be respectively welded to the anode tab sets 62 of different winding cores 6, so as to increase the number of the winding cores 6 in the lower case 2.

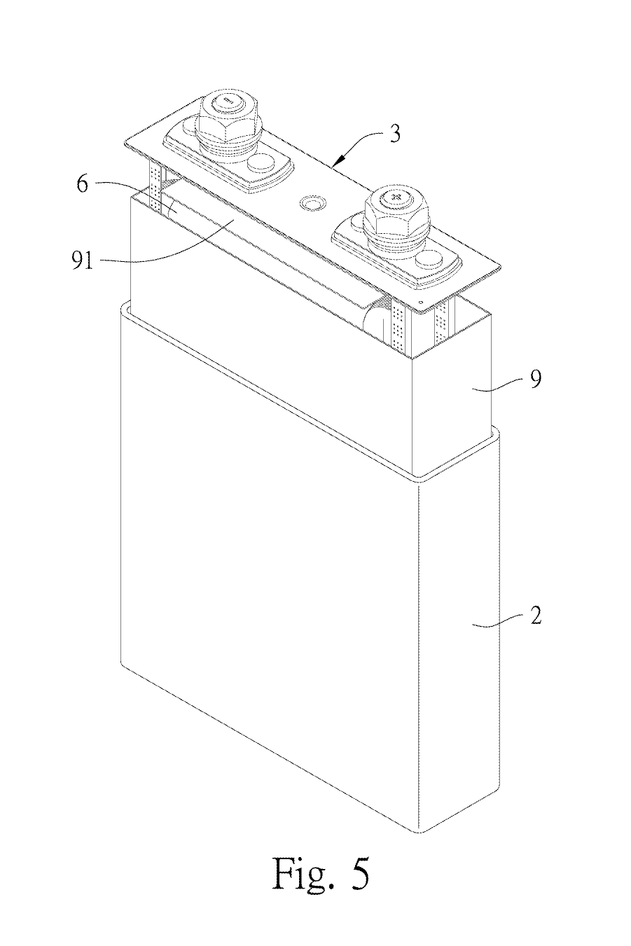

As shown in FIG. 5, which shows a fourth embodiment of a lithium battery core 1 according to the present invention. In this embodiment, the lower case 2 is made of metal material. An insulating sleeve 9 covers the outer peripheries of the winding core and is located between the winding core 6 and the lower case 2. An insulating plate 91 is fixed between the bottom of the cover plate 3 and the top of the winding core 6 in order to avoid the occurrence of short-circuiting.

Therefore, the present invention has the following advantages:

1. According to the present invention, the cathode tab set and the anode tab set are respectively formed at two lateral sides of the winding core while the cathode and the anode conductive sheets are in a large-area electrical connection with the cathode and the anode tab sets. Thereby, it is able to stabilize the voltage and current, fulfill the requirement of the charge and discharge of high-rate and large current, make the heat dissipation effective, lengthen the service time, and ensure the safety of use.

2. According to the present invention, the tops and the bottoms of the cathode tab set and the anode tab set are processed with angle cutting treatment. Thereby, when an electrolyte solution is added into the case, the electrolyte solution could be rapidly absorbed by the anode plate and the cathode plate, so as to avoid the occurrence of short-circuiting.

3. According to the present invention, the first extending part and the third extending part are extended from the cathode conductive sheet while the second extending part and the fourth extending part are extended from the anode conductive sheet. Thereby, these extending parts could be welded onto the cathode tab set and the anode tab set of different winding cores, so as to increase the number of the winding cores in the lower case and thus fulfill the requirement of high-rate and large current.

Therefore, according to above-disclosed descriptions, the present invention can achieve the expected objects to provide a lithium battery core, which could fulfill the requirement of the charge and the discharge of the high-rate and large current, improve the conductivity and the heat dissipation, and ensure the safety of use. It is novel and has industrial use.

What is claimed is:

1. A lithium battery core, comprising a lower case and a cover plate provided to cover the lower case's top, where the cover plate is provided with a first terminal component and a second terminal component; an electrolyte solution and at least a winding core are received in the lower case; each winding core has a cathode tab set and an anode tab set, the cathode tab set is in electrical connection with the first terminal component while the anode tab set in electrical connection with the second terminal component; the lithium battery core being characterized in that:
the cathode tab set and the anode tab set are respectively located at two lateral sides of the winding core;
the first terminal component has a bottom connected with a cathode conductive sheet, and the cathode conductive sheet includes a first positioning part and a first extending part; the first positioning part is in electrical connection with the first terminal component, and the first extending part extends downwardly from one side of the first positioning part in a direction of being generally perpendicular to the first positioning part; and the first extending part is connected with the cathode tab set; and
the second terminal component has a bottom connected with an anode conductive sheet, and the anode conductive sheet includes a second positioning part and a second extending part; the second positioning part is in electrical connection with the second terminal component, and the second extending part extends downwardly from one side of the second positioning part in a direction of being generally perpendicular to the second positioning part; and the second extending part is connected with the anode tab set.

2. The lithium battery core as claimed in claim 1, wherein the first extending part and the second extending part respectively have a U-shape cross-section.

3. The lithium battery core as claimed in claim 2, wherein the first positioning part and the first extending part are in inverse L-shape.

4. The lithium battery core as claimed in claim 3, wherein the cathode conductive sheet further includes a third extending part; the third extending part extends downwardly from another side of the first positioning part in a direction of being generally perpendicular to the first positioning part; and the first positioning part, the first extending part, and the third extending part are in inverse U-shape.

5. The lithium battery core as claimed in claim 2, wherein the second positioning part and the second extending part are in inverse L-shape.

6. The lithium battery core as claimed in claim 5, wherein the anode conductive sheet further includes a fourth extending part; the fourth extending part extends downwardly from another side of the second positioning part in a direction of being generally perpendicular to the second positioning part; and the second positioning part, the second extending part, and the fourth extending part are in inverse U-shape.

7. The lithium battery core as claimed in claim 1, further comprising a first conductive sheet and a second conductive sheet, wherein the first conductive sheet is attached to the first positioning part of the cathode conductive sheet while the second conductive sheet is attached to the second positioning part of the anode conductive sheet.

8. The lithium battery core as claimed in claim 1, wherein the cathode tab set has a top formed with a first upper notch, and the cathode tab set has a bottom formed with a first lower notch.

9. The lithium battery core as claimed in claim 1, wherein the anode tab set has a top formed with a second upper notch, and the anode tab set has a bottom formed with a second lower notch.

10. The lithium battery core as claimed in claim 1, further comprising an insulating sleeve, wherein the lower case is made of metal material, and the insulating sleeve covers the winding core and is located between the winding core and the lower case.

11. The lithium battery core as claimed in claim 1, wherein the first positioning part and the first extending part are in inversely L-shape.

12. The lithium battery core as claimed in claim 11, wherein the cathode conductive sheet further includes a third extending part; the third extending part extends downwardly from another side of the first positioning part in a direction of being generally perpendicular to the first positioning part; and the first positioning part, the first extending part, and the third extending part are in inverse U-shape.

13. The lithium battery core as claimed in claim 1, wherein the second positioning part and the second extending part are in inverse L-shape.

14. The lithium battery core as claimed in claim 13, wherein the anode conductive sheet further includes a fourth extending part; the fourth extending part extends downwardly from another side of the second positioning part in a direction of being generally perpendicular to the second positioning part; and the second positioning part, the second extending part, and the fourth extending part are in inverse U-shape.
